(19) United States
(12) Patent Application Publication
(10) Pub. No.: US 2002/0090863 A1
(43) Pub. Date: Jul. 11, 2002

(54) Plug connector with a switch

(76) Inventors: Roland Baumgaertner, Bonndorf (DE); Volker Rombch, Furtwangen (DE); Frank Roese, Hamburg (DE)

Correspondence Address: Samuels, Gauthier & Stevens LLP, Suite 3300, 225 Franklin Street, Boston, MA, 02110, US

(21) Appl. No.: 09/982,539

(22) Filed: Oct. 18, 2001

(30) Foreign Application Priority Data
Oct. 18, 2000 (DE) 100 51 791.9

(51) Int. Cl. H01R 11/22; H01R 29/00

(52) U.S. Cl. 439/851; 439/188

(57) ABSTRACT

A plug connector has a U-shaped snap-on clip with a web, which incorporates a contact lug. The web is seated in a slot of the casing. A contact is situated at the end of the U-shaped snap-on clip, between its arms. An opening for inserting a contact pin is situated in the top side of the housing. This contact pin spreads the arms of the U-shaped snap-on clip, so that they detach from the contact. This plug connector, which is especially suited for use in a cordless radiotelephone, is distinguished by a small structural size, low production costs, a small number of components, high contact reliability, and an especially low juncture resistance.

### BACKGROUND OF THE INVENTION

The invention relates to a plug connector with a switch. Plug connectors with switches are used e.g. in cordless telephones and consequently should be as small as possible, but nevertheless should be cheap to produce.

It is therefore the object of the invention to design a plug connector with a switch so that it is as small as possible and nevertheless cheap to produce.

### SUMMARY OF THE INVENTION

The invention achieves this object through the characteristics specified in claim 1, in that the web of a U-shaped snap-on clip, with a first contact, is disposed in a casing, and that a second contact is situated between the arms of the U-shaped snap-on clip, and that a contact pin can be placed between the arms of the U-shaped snap-on clip, such that the arms of the U-shaped snap-on clip are separated from the second contact when the contact pin is inserted.

The U-shaped snap-on clip comprises two equal arms and a web connecting these and at right angles to them. The first contact is incorporated into this web, e.g. as a contact lug. The U-shaped snap-on clip with the contact lug preferably is made of one piece.

In a first embodiment, the second contact is situated at the end of the U-shaped snap-on clip, between its arms. Alternatively, the second contact can also be placed between the arms from the top or from the bottom.

The web of the U-shaped snap-on clip preferably is placed into a slot of the casing.

The casing of the plug connector is made e.g. of a nonconducting material. It is at least partially covered with a metal coating for shielding purposes.

The contact pin is placed between the arms of the U-shaped snap-on clip either from the top or from the bottom.

In a second embodiment of the invention, the contact pin is placed between the arms of the U-shaped snap-on clip from the rear, against the front side of the web.

The inventive plug connector has the following advantages: First, the U-shaped snap-on clip is loaded symmetrically. This leads to a second advantage, namely that the fastening of the U-shaped snap-on clip is not subject to stress. Finally, the third advantage is that two contact surfaces are available both for the second contact and for the contact pin, one surface at one arm and the other at other arm of the U-shaped snap-on clip. This increases the reliability of contact and at the same time achieves an especially low juncture resistance.

These and other objects, features and advantages of the present invention will become more apparent in light of the following detailed description of preferred embodiments thereof, as illustrated in the accompanying drawings.

### BRIEF DESCRIPTION OF THE DRAWING

FIG. 1 shows an embodiment of the inventive plug connector from below;

FIG. 2 shows a longitudinal section through the embodiment;

FIG. 3 shows the casing of the embodiment, from the top, in perspective; and

FIG. 4 shows the casing of the embodiment from below, in perspective.

### DETAILED DESCRIPTION OF THE INVENTION

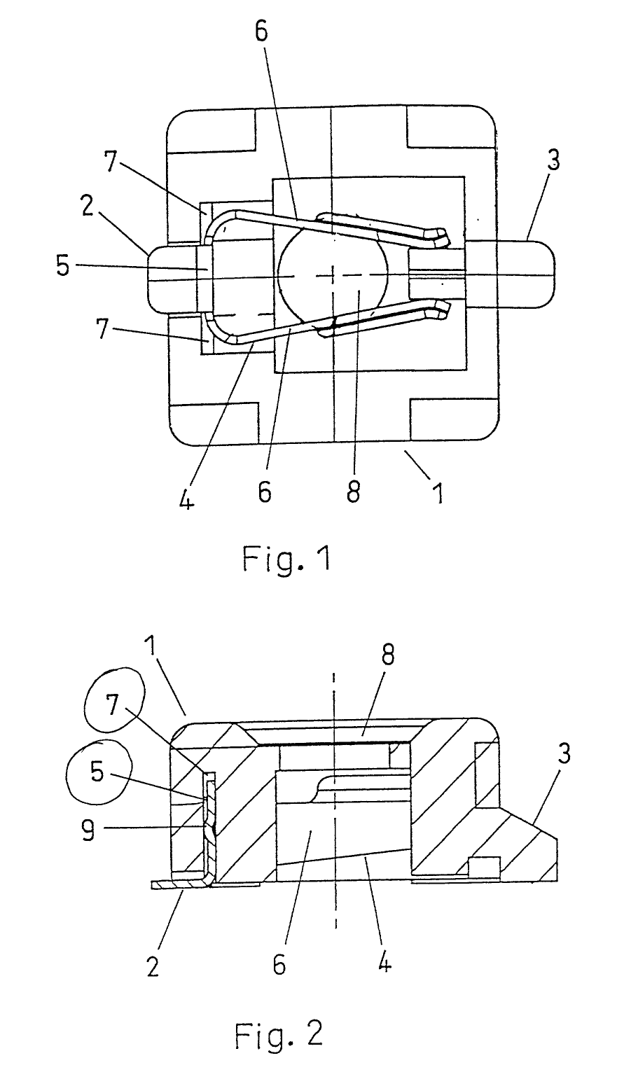

FIG. 1 shows the embodiment from below.

The web 5 of the U-shaped snap-on clip 4 is seated in a slot 7 of the casing 1. A contact lug 2, which forms the first contact, is situated on the web 5. A second contact 3 is placed at the end of the U-shaped snap-on clip 4, between its arms 6. However, this contact is not constructed as a separate part but is incorporated into the casing 1. The casing 1 is made of an electrically nonconducting material, e.g. a plastic. To create an electrical contact, the second contact 3 is covered with a metal coating. An opening 8 to insert a contact pin is situated on the top side of the casing 1. The contact pin is placed between the two arms 6 of the U-shaped snap-on clip 4, so as to spread the two arms 6 and isolate them from the second contact 3. The contact pin is now electrically connected, via the U-shaped snap-on clip 4, to the first contact 2, which is constructed as a contact lug.

FIG. 2 shows a longitudinal section through the embodiment. A bead 9 is incorporated into the web 5, to secure the U-shaped snap-on clip 4 in the slot 7.

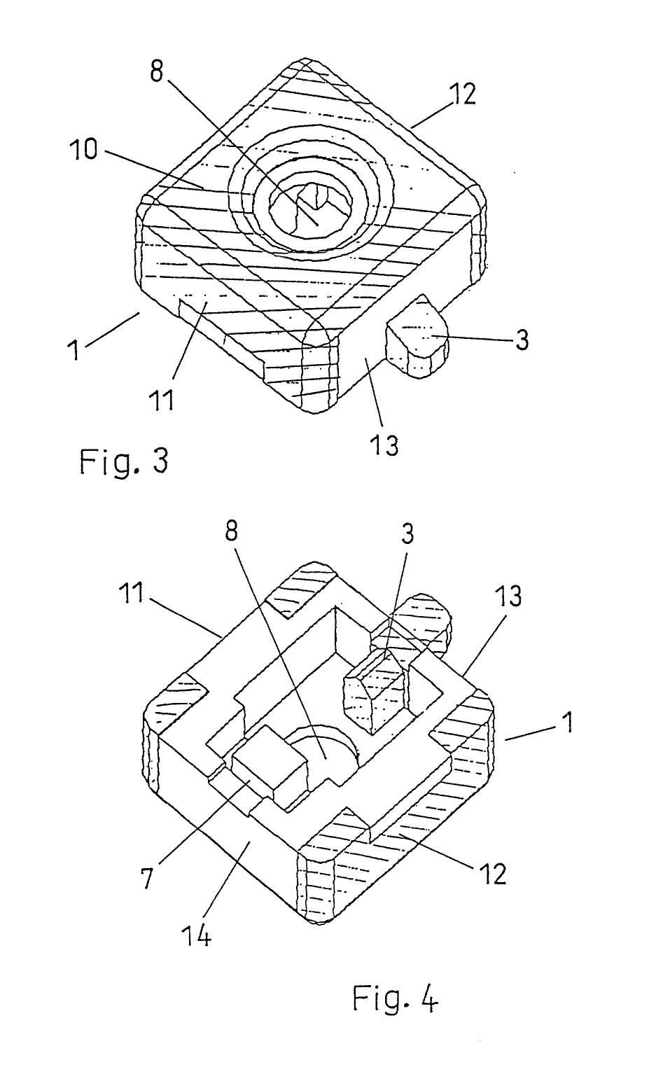

FIG. 3 shows the housing, viewed from the top, in perspective.

The opening 8 for the contact pin is incorporated into the top side of the housing 1. The second contact 3, whose surface is covered with a metal coating, partly protrudes from the front side of the housing 1.

FIG. 4 shows the casing from below, in perspective.

The second contact, covered with a metal coating 3, is incorporated into the front side 13 of the housing 1. The slot 7, for inserting the web 5 of the U-shaped snap-on clip 4, is situated on the back side 14 of the housing 1. The opening 8 for the contact pin can be seen in the top side 10 of the housing 1.

The top side 10 as well as the right side 11 and the left side 12 of the housing 1 are covered with a metal coating, so as to form a chassis ground, which can be connected to an earth ground. The U-shaped snap-on clip can be made e.g. of metal or of a plastic that is covered with a metal coating.

Because the U-shaped snap-on clip is loaded symmetrically, its attachment point remains unstressed. Because the U-shaped snap-on clip extends horizontally, the structural height of the device can be kept small. The integral casing of plastic, with a metal coating in certain places, performs the following functions:

HF-shielding, stationary contact, and insulation.

In summary, the inventive plug connector is distinguished by a small structural height, low production costs, a small number of components, high contact reliability, and an especially low juncture resistance.

Although the present invention has been shown and described with respect to several preferred embodiments thereof, various changes, omissions and additions to the form and detail thereof, may be made therein, without departing from the spirit and scope of the invention.

What is claimed is:

1. A plug connector with a switch, comprising the web of a U-shaped snap-on clip, with a first contact, is disposed in a casing, and that a second contact is situated between the arms of the U-shaped snap-on clip, and that a contact pin can be placed between the arms of the U-shaped snap-on clip, such that the arms of the U-shaped snap-on clip are separated from the second contact when the contact pin is inserted.

2. The plug connector of claim 1, characterized in that the first and the second contacts are disposed collinear with the longitudinal axis of the U-shaped snap-on clip, and the contact pin can be placed perpendicular to this, between the arms of the U-shaped snap-on clip.

3. The plug connector of claim 1, characterized in that the first contact and the insertable contact pin are disposed collinear with the longitudinal axis of the U-shaped snap-on clip, and that the second contact is inserted perpendicular to this, between the arms of the U-shaped snap-on clip.

4. The plug connector of claim 2, characterized in that the casing is made of an electrically insulating material.

5. The plug connector of claim 4, characterized in that the second contact is designed as a contact that is incorporated into the housing, and that its surface is covered with a metal coating.

6. The plug connector of claim 5, characterized in that the web of the U-shaped snap-on clip is seated in a slot of the housing.

7. The plug connector of claim 6, characterized in that the first contact is designed as a contact lug on the web of the U-shaped snap-on clip.

8. The plug connector of claim 7, characterized in that a bead is incorporated into the web of the U-shaped snap-on clip.

9. The plug connector of claim 8, characterized in that the U-shaped snap-on clip consists of plastic that is covered with a metal coating.

10. The plug connector of claim 9, characterized in that the U-shaped snap-on clip consists of metal.

11. The plug connector of claim 10, characterized in that the first contact and the U-shaped snap-on clip are produced in one piece.

12. The plug connector of claim 11, characterized in that the casing is at least partially covered with a metal coating for shielding.

13. The plug connector of claim 11, characterized in that the top side as well as the right and left sides of the casing are covered with a metal coating for connection to ground.
